(19) United States
(12) Patent Application Publication
(10) Pub. No.: US 2011/0139364 A1
(43) Pub. Date: Jun. 16, 2011

(54) Chemical modification of chromate conversion coated aluminum work pieces

(76) Inventors: Luis J. Matienzo, Endicott, NY (US); David William Sissenstein, JR., Endwell, NY (US)

(21) Appl. No.: 12/653,680

(22) Filed: Dec. 16, 2009

(51) Int. Cl. B32B 38/00; B32B 37/12

(52) U.S. Cl. 156/272.6; 156/497; 156/379.7; 156/60

(57) ABSTRACT

A method and assembly for chemically modifying chromate converted aluminum work pieces to improve adhesion. The chromate converted aluminum work pieces are treated with oxygen plasma within the range of 500 W to 1500 W for approximately 5 to 30 minutes to chemically modify the free cyanide in the chromate coating. The free cyanide is modified into functional groups that chemically bond with silicone based adhesives. Adhesion strength of at least 100% improvement is observed. An aluminum heat sink is attached to modules with a silicone based elastomer containing a thermally enhanced additive. The thermally enhanced adhesive is dispensed onto application specific integrated circuit (ASIC) chips, memory chips, or laminates of the modules. Subsequently, the assembled device is cured at 150° C. for approximately one hour.

### FIELD OF INVENTION

The present invention relates to an assembly for the chemically modifying chromate conversion coated aluminum work pieces to improve adhesion to silicone based elastomers and methods of making same.

### BACKGROUND OF THE INVENTION

Historically, typical applications of complex microelectronic products use adhesives to provide contact between operating silicon chips and heat spreaders. The material of choice for a heat spreader is an aluminum alloy protected against environmental degradation effects through the use of chromate based conversion coatings.

The composition of various conversion coatings for aluminum has been well documented; some formulations use Fe(CN)₆⁴⁻ ions as catalysts of coating deposition. The presence of these groups can be detected easily using techniques such as Fourier Transform Infrared Spectroscopy (FTIR) and X-ray Photoelectron Spectroscopy (XPS). Thus, it is expected that Al-coated surfaces with these types of coatings will contain some level of cyanide groups. But the presence of these cyanide groups caused adhesion problems for silicone based adhesives. Therefore, it is advantageous to improve adhesion by removing the residual cyanide groups from the metallic surfaces to improve adhesion using a silicone based adhesive.

Silicone based elastomers are used as materials for joining heat spreaders to silicon devices. A material of choice is one that yields desirable adhesion strength and adequate thermal conductivity to fast transfer heat quickly during power-on operations. A representative adhesive formulation that meets these requirements is TSE3281G adhesive produced by General Electric Co.

Practical adhesion of an adhesive of this particular type is obtained by in situ polymerization of the reactive components and then via condensation reactions of groups present on the product with hydroxyl groups on a substrate surface to yield M-O—Si bonds. The polymerization reaction is produced through the use of a Pt-based catalyst. The reaction for interaction of the adhesive components is shown in FIGS. 1A and 1B.

The intermediate in this polymerization scheme uses a Pt-catalyst that must form an intermediate with double bonds present in one of the components. These interactions are produced through π bonding. The unsaturated groups are very soft bases in the sense of the concept of soft and hard acids and bases. This reaction can easily be affected by competition with another soft base to form Pt intermediates. In the particular case described hereinbelow, a cyanide group has strong reactivity toward Pt. The net result will be is a lower than desired value of practical adhesion upon curing.

Oxygen plasma treatment of these Al-coated surfaces with a chromate coating induces the transformation of the residual cyanide groups into other nitrogen-containing species that are more acidic and thus less reactive with platinum catalysts. In addition, the oxygen interaction with surface chromium and iron atoms leads to a higher level of oxidation, which also induces more surface acidity and can accommodate more bonding interaction of the adhesive with the metal surface without need for mechanical modification for roughness enhancement. The chemical transformation of the cyanide groups by oxygen plasma treatments can be observed by collecting high resolution N1s XPS data for the resulting surfaces.

The practical results of experiments have shown that the use of oxygen treatments with selected powers in the range of 500 W to 1500 W for 30 minutes yields equivalent surface-chemical results. In addition, these surface modifications enhance practical adhesion values by 100% over the typical values of unmodified surfaces.

The approach described herein is applicable to other situations in which silicon based adhesives utilize a Pt-based catalyst.

The existing prior art tends to deal mostly with improving adhesives to metallic surfaces using processes different from the inventive process described hereinbelow.

U.S. Pat. No. 5,847,929 for ATTACHING HEAT SINKS DIRECTLY TO FLIP CHIPS AND CERAMIC CHIP CARRIERS by Bernier et al. discloses aluminum or copper heat sink attached to a ceramic cap or exposed semiconductor chip using an adhesive of silicone or flexible epoxy. The aluminum may be coated by anodizing or chromate conversion or the copper may be coated with nickel or gold on chromium. Such structures are useful for flip chip attachment to flexible or rigid organic circuit boards or modules such as CQFP, CBGA, CCGA, CPGA, TBGA, PBGA, DCAM, MCM-L, and other chip carrier packages in which the back side of chips are connected directly to heat sinks. The adhesive contains materials having high thermal conductivity and a low coefficient of thermal expansion (CTE) in order to provide increased thermal performance. This patent fails to mention the use of a generalized surface mount (GSM) placement machine that improves placement of the heat sink or the curing process. Moreover, this patent fails to disclose a method of improving adhesion utilizing oxygen plasma to chemically modify the surface chemistry of the chromate conversion coating, which is important for improving the adhesive strength of the silicone based adhesive to the aluminum heat sink.

U.S. Pat. No. 6,379,750 for PROCESS FOR ENHANCING THE ADHESION OF ORGANIC COATINGS TO METAL SURFACES by Wojcik et al. discloses a process for increasing the adhesion of organic coatings to metal surfaces, particularly aluminum and aluminum alloys. The process involves an adhesion promoting composition in treating the metal surface prior to application of the organic coating. The adhesion promoting composition comprises a nitro sulfonic acid. A chromating step is optionally employed.

U.S. Pat. No. 6,206,981 for PROCESS FOR ENHANCING THE ADHESION OF ORGANIC COATINGS TO METAL SURFACES by Melvin R. Jenkins discloses a process for increasing the adhesion of organic coatings to metal surfaces, particularly aluminum and aluminum alloys. The process involves an adhesion promoting composition in conjunction with a chromating composition in treating the metal surface prior to application of the organic coating. The adhesion promoting composition comprises (i) 1,2-bis(beta-chloroethoxy)ethane, (ii) a glycol ether, (iii) an oxidizing acid, and (iv) a nitro sulfonic acid.

U.S. Pat. No. 5,178,690 for PROCESS FOR SEALING CHROMATE CONVERSION COATINGS ON ELECTRODEPOSITED ZINC by Jose A. O. Maiquez discloses a process for forming chromate conversion coatings on zinc surfaces by treating the zinc surface with an aqueous acidic chromating solution that contains hexavalent chromium and a soluble inorganic salt that has a cation that forms an insoluble organic silicate. Thereafter, the thus-formed chromate conversion coating is treated with an aqueous alkaline silicate solution that contains fluoride ions.

U.S. Pat. No. 4,146,410 for NON-FERRICYANIDE CHROMATE CONVERSION COATING FOR ALUMINUM SURFACES by Earl R. Reinhold discloses a composition and method for applying a conversion coating on aluminum and aluminum alloy surfaces. In the method of this disclosure, an aluminum containing metal surface is contacted with a ferricyanide free aqueous acidic solution containing zinc, hexavalent chromium, fluoride, and molybdate ions. The ferricyanide free aqueous acidic solution in the prior art contains zinc, hexavalent chromium, fluoride and molybdate ions.

The prior art listed above all deals with a form of modification regarding adhesion and metallic surfaces. None of the prior art discloses a thermally enhanced adhesive by cooling the application specific integrated circuit (ASIC) comprising a similar assembly and curing process. As stated above, often, silicone based elastomers are used as adhesives for joining heat spreaders to silicon devices. When performing this process, a material of choice is one that yields desirable adhesion strength and adequate thermal conductivity to transfer heat quickly during power-on operations.

### SUMMARY OF THE INVENTION

Disclosed is a method of chemical modification of chromate conversion coated aluminum work pieces to improve adhesion to silicone based elastomers. More specifically, the invention is applicable to situations in which silicone based adhesives are formed using a Pt-based catalyst.

A thermally enhanced adhesive is obtained for the process of cooling the application specific integrated circuit (ASIC) comprising a similar assembly and curing process. The present invention enhances adhesion by removing the problem of residual cyanide groups in the chromate coating. The ferric cyanides used in the chromate process usually interfere with the curing of the silicone based adhesive. These silicone elastomers utilize a platinum based catalyst. It has been shown that residual cyanide groups in the chromate coating have strong reactivity toward the platinum catalyst in the silicone. Thus, separation occurs. Removing the cyanide groups from the coating enhances adhesion.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a chemical representation showing the hydrosilylation of platinum catalysts to yield cross-linked silicones; and

FIG. 2 is a schematic view of the heat sink assembly in accordance with the present invention for improving adhesion of the aluminum coated work pieces to silicone based elastomers.

### DETAILED DESCRIPTION OF THE PREFERRED EMBODIMENT

For a better understanding of the present invention, together with other and further objects, advantages, and capabilities thereof, reference is made to the following disclosure and appended claims in connection with the above-described drawings.

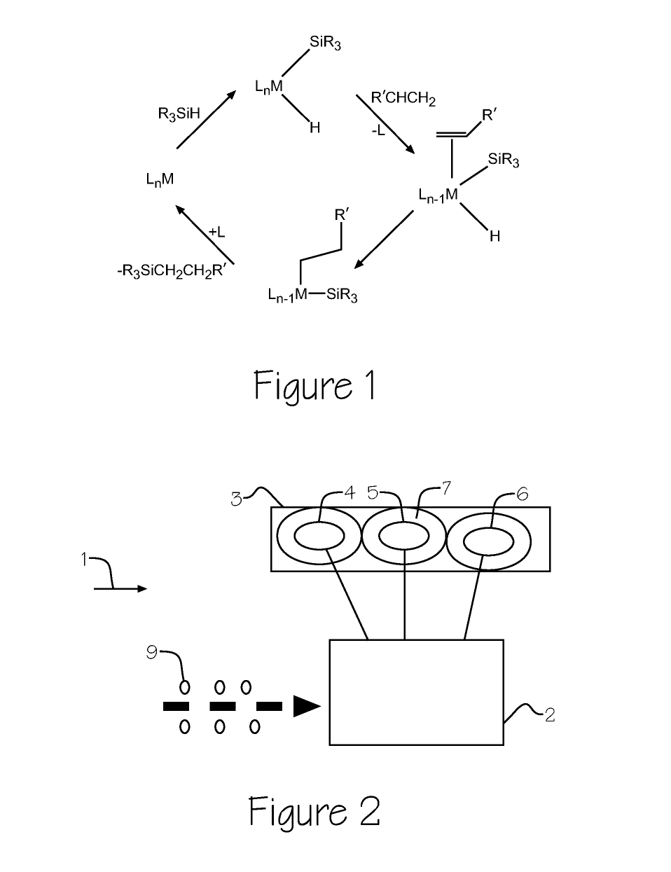

FIG. 1 is a chemical representation of hydrosilylation of platinum catalysts in order to yield cross-linked silicones. Practical adhesion of an adhesive is obtained by in situ polymerization of the reactive components and then via condensation reaction of groups present on the product with hydroxyl groups on a substrate surface to yield M-O—Si bonds. The polymerization reaction is produced through the use of a platinum based catalyst. The intermediate in the polymerization scheme uses a platinum catalyst that must form an intermediate with double bonds present in one of the components. These interactions are produced through π bonding. The net result is cross linked silicone elastomers with a lower than desired value of practical adhesion.

Referring now also to FIG. 2, the heat sink assembly 1 for improving adhesion of chromate coated aluminum work pieces to silicone based elastomers is shown schematically. Heat sink assembly of chromate coated aluminum 1 is treated with oxygen plasma. Oxygen plasma treatment with selected powers in the range of 500 W to 1500 W from about 5 to 30 minutes is utilized. The oxygen plasma treatment induces the transformation of the residual cyanide groups into other nitrogen-containing species that are more acidic and thus less reactive with platinum catalysts. In addition, the oxygen interaction with surface chromium and iron atoms leads to a higher level of oxidation which also induces more surface acidity and can accommodate more bonding interaction of the adhesive with the metal surface without any need for mechanical modification to increase roughness.

The module assembly includes a plurality of modules 3 having a silicone based elastomer 7. The plurality of modules 3 contain at least one of the group including an application specific integrated circuit (ASIC) chip 4, a memory chip 5, or various laminates 6.

The silicone based elastomer 7 is a thermally enhanced adhesive that is designed to help cool the ASIC chips 4, memory chips 5 or laminates 6 of the plurality of modules 3.

A GSM placement machine (not shown) can be used but is not necessary to attach the heat sink 2 and the plurality of modules 3. Means are provided for curing the assembly for approximately 1 hour at 150° C., such curing means being well known in the art.

The approach described here is applicable to other situations in which silicon-based adhesives are formed using a Pt-based catalyst.

Since other combinations, modifications and changes varied to fit particular operating requirements and environments will be apparent to those skilled in the art, the invention is not considered limited to the chosen preferred embodiments for purposes of this disclosure, but covers all changes and modifications which do not constitute departures from the true spirit and scope of this invention.

Having thus described the invention, what is desired to be protected by Letters Patent is presented in the subsequently appended claims.

What is claimed is:

1. An assembly for improving adhesion of chromate conversion coated aluminum work pieces to silicone based elastomers comprising:
a heat sink comprising a thermally operative material;
means for introducing oxygen to heat said heat sink;
a plurality of modules where an elastomer has been applied;
means for attaching said heat sink to said plurality of modules; and
means for curing said assembly.

2. The assembly of claim 1, wherein said operative material of said heat sink is chosen from one of the group: aluminum and chromate conversion coated aluminum.

3. The assembly of claim 1, wherein said plurality of modules contains at least one from the group: an application specific integrated circuit (ASIC) chip; memory chips; any heat generating electronic components that require cooling; and various laminates.

4. The assembly of claim 3, wherein said elastomer is silicone based.

5. The assembly of claim 4, wherein said elastomer is a thermally enhanced adhesive designed to help cool said ASIC chips, memory chips, electronic components, or laminates of said modules

6. The assembly of claim 5, wherein said means for attaching said heat sink to said plurality of modules comprises a GSM placement machine.

7. The assembly of claim 5, wherein said means for curing said assembly is operational for approximately 1 hour at approximately 150° C.

8. The assembly of claim 7, wherein said means for introducing oxygen operates within the range of 500 W to 1500 W for approximately 5 to 30 minutes.

9. The assembly of claim 8 wherein said means for introducing oxygen to said heat sink comprises a plasma machine.

10. A method for chemically modifying chromate converted aluminum work pieces comprising an aluminum heat sink attached to modules with a silicone based elastomer containing a thermally enhanced adhesive, the method comprising:
a) treating said aluminum heat sink device with oxygen;
b) dispensing said thermally enhanced adhesive onto an electronic device;
c) pressing said aluminum heat sink onto said modules; and
d) curing the assembled device at approximately 150° C. for approximately 1 hour.

11. The method of claim 10, wherein said electronic device is chosen from at least one of the group: application specific integrated circuit (ASIC) chips, memory chips, and laminates of said module with a silicone based elastomer.

12. The method of claim 10, wherein said pressing step (c) is performed utilizing a GSM placement machine.

13. The method of claim 10, wherein said curing step (d) is performed utilizing a plasma machine.

14. The method of claim 10, wherein said treating step (a) is performed at a power within the range of 500 W to 1500 W for approximately 5 to 30 minutes.
